(19) United States
(12) Patent Application Publication
(10) Pub. No.: US 2009/0235533 A1
(43) Pub. Date: Sep. 24, 2009

(54) UTILITY KNIFE WITH A FIXED BLADE AND A SELF-RETRACTING BLADE

(76) Inventor: Yin Han Huang, Taichung (TW)

Correspondence Address: SAM CHEN, 7F-1, 293, ROOSEVELT ROAD, SEC 3, TAIPEI, TW

(21) Appl. No.: 12/053,669

(22) Filed: Mar. 24, 2008

(51) Int. Cl. B26B 5/00; B26B 1/08; B26B 3/08

(52) U.S. Cl. 30/143; 30/162; 30/152

(57) ABSTRACT

A utility knife includes a fixed blade in a first handle at one end and a self-retracting blade in a second handle at the other end. The utility knife further includes a locking member slidably positioned on a bifurcation of the second handle adjacent the first handle. In a locked position of the locking member either blade can be used. The locking member is adapted to slide toward the first handle to disengage the housing of the second handle from the first handle prior to replacing the self-retracting blade. A user may have two blade options when using the utility knife, thereby increasing working efficiency.

### BACKGROUND OF THE INVENTION

1. Field of Invention

The invention relates to utility knives and more particularly to a utility knife having a fixed blade in a first handle at one end and a self-retracting blade in a second handle at the other end.

2. Description of Related Art

Utility knife is a common tool used in various trades and crafts for a variety of purposes. Conventionally, the blade of a utility knife is retractable and is solely capable of performing a single function (e.g., cutting a paper box). However, it suffers from a couple of disadvantages. For example, it is not uncommon that a person may carry two or more utility knives when doing a job. This is cumbersome. Moreover, the person has to replace the utility knife being used with another utility knife of a different function if such need arises. This can lower working efficient and is inconvenient. Thus, the need for improvement still exists.

There have been numerous suggestions in prior patents for utility knife. For example, U.S. Pat. No. 7,316,070 discloses a self-retracting utility knife.

### SUMMARY OF THE INVENTION

It is therefore one object of the invention to provide a utility knife having a fixed blade in a first handle at one end and a self-retracting blade at the other end so that a user may have two blade options when using the utility knife, thereby increasing working efficiency.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of utility knife according to the invention;

FIG. 2 is an exploded view of the utility knife;

FIG. 3 is a lengthwise sectional view of the second handle of the utility knife of FIG. 1;

FIG. 4 is a view similar to FIG. 3 where the first handle is being disengaged from the housing of the second handle by pulling prior to replacing the retractable second blade; and

FIG. 5 is a view similar to FIG. 1 where the retractable blade has been extended by pushing the actuator.

### DETAILED DESCRIPTION OF THE INVENTION

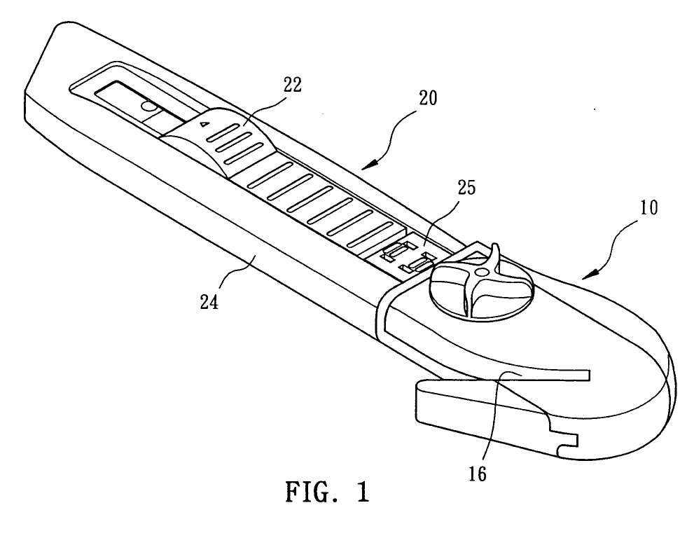

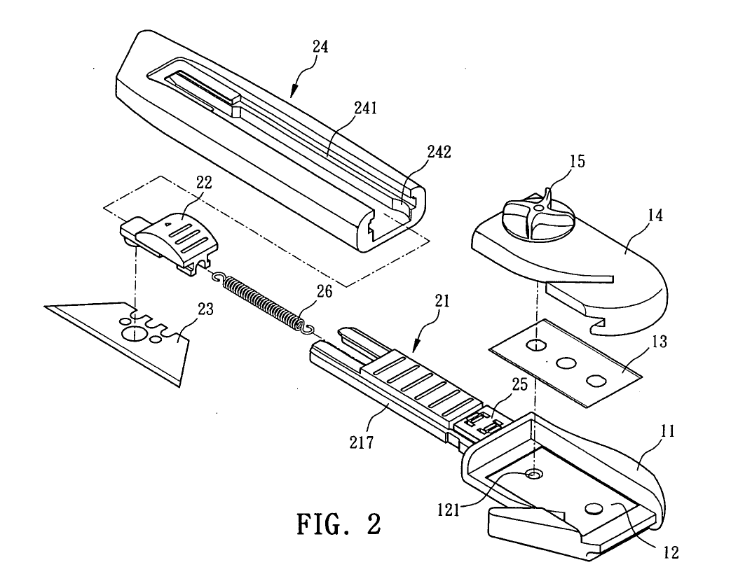

Referring to FIGS. 1 to 5, a utility knife in accordance with a preferred embodiment of the invention comprises a first handle 10 and an opposite second handle 20. Each component is discussed in detail below.

The first handle 10 comprises a first portion 11 including a rectangular recess 12 having a threaded hole 121, a second portion 14 complimentary to the first portion 11, a rectangular first blade 13 fitted on the recess 12, the first blade 13 having two cutting edges and three equally spaced holes (not numbered) formed along a lengthwise central line in which the hole adjacent one end of the first blade 13 is aligned with the threaded hole 121, a screw 15 adapted to drive through a hole (not numbered) of the second portion 14 and the end hole of the first blade 13 into the threaded hole 121 to threadedly secure the second portion 14 and the first portion 11 together to assemble a hook-shaped housing (not numbered), and a notch 16 formed at a bend of the housing in which a portion of the first blade 13 is exposed at the notch 16.

The orientation of the first blade 13 can be changed when a portion of either cutting edge thereof becomes worn or damaged. That is, the first blade 13 can be flipped 180 degrees relative to a widthwise axis of symmetry thereof. Also, one cutting edge of the first blade 13 can be flipped 180 degrees relative to a lengthwise axis of symmetry thereof to expose a portion of the other cutting edge thereof at the notch 16 when one cutting edge thereof becomes worn or damaged.

The second handle 20 comprises a bifurcation 21 extending out of the first handle 10 and aligning therewith, the bifurcation 21 including a first section 211 of reduced width integrally formed with the first portion 11 of the first handle 10, a second section 212 having a width larger than that of the first section 211, and two opposite slanting projections 213 at a joining portion of the first and second sections 211, 212, two flexible latches 214 each extending from the joining portion of the first and second sections 211, 212 toward the first portion 11 of the first handle 10, two heads 215 having an outwardly convex portion each on an end of the latch 214, a first spring-engaging portion 216 formed on the bottom of the first section 211 of the bifurcation 21, and two slides 217 on both sides of the second section 212.

The second handle 20 further comprises a housing 24 having a front blade opening (not numbered), a lengthwise central slot (not numbered), two parallel grooves 241 on both sides of the slot, two depressions 242 at both open ends of the grooves 241; an actuator 22 having a knob (not numbered) with a convex manually engageable surface (not numbered) so that a person may move the actuator 22 axially through the slot between retracted and extended positions; a coil spring 26 having one end anchored at a second spring-engaging portion 221 on the bottom of the actuator 22 and the other end anchored at the first spring-engaging portion 216 so that the actuator 22 is always pulled to engage with a transverse member (not numbered) formed across the legs of the bifurcation 21 (i.e., on the rear portion of the second section 212 of the bifurcation 21) when the actuator 22 is in an inoperative position (i.e., retracted position); a trapezoidal second blade 23 releasably secured to a blade carrier (not numbered) on the bottom of the actuator 22; and a locking member 25 slidably positioned on a portion between the transverse member and the first handle 10 (i.e., sitting on the first section 211), the locking member 25 including two flexible legs 251 each disposed between the first section 211 and the latch 214 to slidably fasten on the bottom of the first section 211, and two opposite ridges 252 each formed on an end of the leg 251 facing the first handle 10.

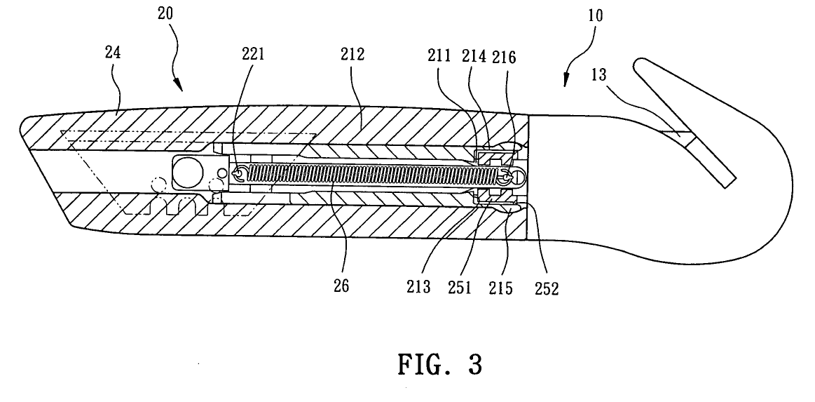

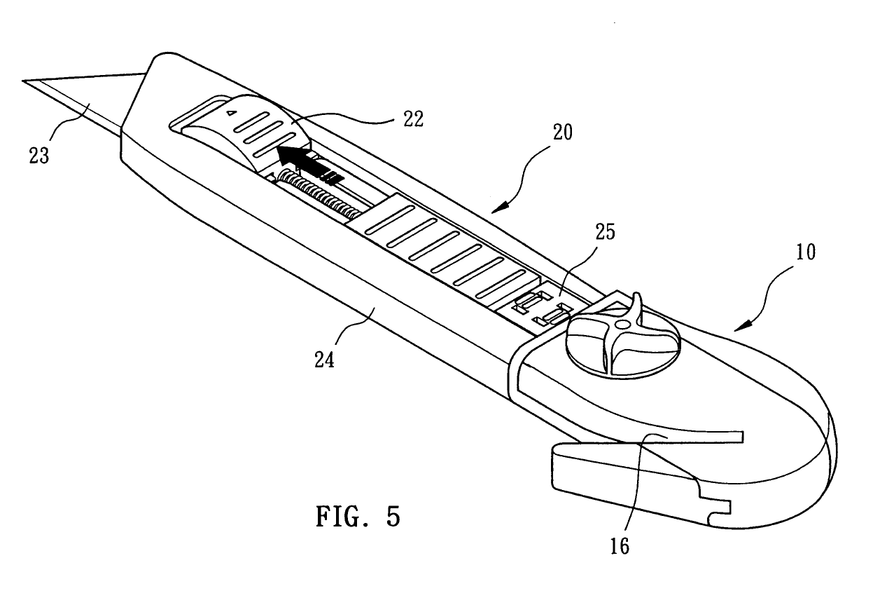

A first operation (i.e., cutting operation) of the invention will be described in detail below. As shown in FIG. 3, the locking member 25 is disposed between the rear portion of the second section 212 of the bifurcation 21 and the first handle 10 and the heads 215 are matingly engaged with the depressions 242 because the ridges 252 are urged against the heads 215. Hence, the housing 24 of the second handle 20 is secured to the first handle 10. In this position, a user may use the exposed first blade 13 to cut an object. In this position, a user may alternatively push the knob of the actuator 22 to move the actuator 22 axially through the slot of the housing 24 to extend the second blade 23 out of the blade opening of the housing 24 for cutting (see FIG. 5). It is envisaged that the second blade 23 will automatically retract into its inoperative position due to the releasing of the compression force of the spring 26 after releasing the actuator 22.

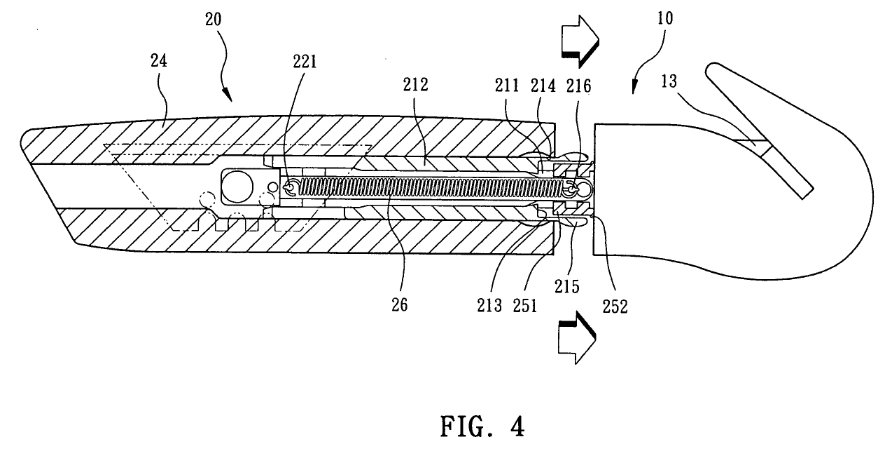

A second operation (i.e., the second blade 23 replacement operation) of the invention will be described in detail below. As shown in FIG. 4, the user may slide the locking member 25 toward the first handle 10 to disengage the ridges 22 from the heads 215. Next, the user may slightly push the housing 24 away from the first handle 10 to cause the heads 215 to clear the depressions 242. Thereafter, the housing 24 can be detached from the bifurcation 21 by further pushing. Thereafter, the user may replace the worn or damaged second blade 23 with a new one.

While the invention herein disclosed has been described by means of specific embodiments, numerous modifications and variations could be made thereto by those skilled in the art without departing from the scope and spirit of the invention set forth in the claims.

What is claimed is:

1. A utility knife comprising:
a hook-shaped first handle comprising a first portion and a complimentary second portion releasably secured to the first portion to assemble a first housing;
a first blade releasably fastened in the first housing and having a portion exposed at a bending portion of the first housing;
a straight second handle comprising a bifurcation including a first section extending out of the first portion of the first handle and a second section having a width different from that of the first section, the second section defining a path between its two legs, and two latches extending from a joining portion of the first and second sections toward the first portion of the first handle, the latches having a mating member, and a second housing including a front blade opening, a lengthwise slot aligned with the path in the second section, two parallel grooves on both sides of the slot, and two corresponding mating members at both open ends of the grooves;
an actuator slidably fastened in the slot;
a second blade releasably fastened on the bottom of the actuator;
a biasing member interconnecting the actuator and the bifurcation for biasing the actuator toward a retracted position of the second blade; and
a locking member slidably positioned on the first section and comprising two flexible legs each disposed between the first section and the latch, and two opposite urging members each on an end of the leg facing the first handle;
wherein in a locked position of the locking member the urging members are urged against the latches to secure the second housing to the first handle by engaging the mating members with the corresponding mating members;
wherein in the locked position of the locking member the actuator is adapted to move axially through the slot between the retracted position of the second blade and an extended position thereof; and
wherein the locking member is adapted to slide toward the first handle to disengage the urging members from the latches and disengage the mating members from the corresponding mating members so that the second housing is adapted to detach from the bifurcation.

2. The utility knife of claim 1, wherein the first blade has a first cutting edge and an opposite second cutting edge.

3. The utility knife of claim 1, wherein the second blade is trapezoidal.

4. The utility knife of claim 1, wherein the mating members are raised members and the corresponding mating members are depressed members.

5. The utility knife of claim 1, wherein the mating members are depressed members and the corresponding mating members are raised members.

6. The utility knife of claim 1, wherein the width of the second section is larger than that of the first section.

7. The utility knife of claim 1, wherein the urging members are ridges.

8. The utility knife of claim 1, wherein the biasing member is a coil spring.
